(19) United States
(12) Patent Application Publication
(10) Pub. No.: US 2026/0138891 A1
(43) Pub. Date: May 21, 2026

(54) WASTEWATER VALVLE ARRANGEMENT

(71) Applicant: Odour Technologies Pty Ltd, Queensland (AU)

(72) Inventor: Peter C. Beetham, Queensland (AU)

(21) Appl. No.: 18/948,850

(22) Filed: Nov. 15, 2024

(51) Int. Cl. C02F 1/00; F16K 31/20

(52) U.S. Cl. CPC C02F 1/004; F16K 31/20; C02F 2201/005

(57) ABSTRACT

The present invention relates to a wastewater valve arrangement. The arrangement includes a first receptacle for receiving a filter to filter wastewater, a second receptacle for receiving the filtered wastewater, and a valve. The valve includes a seal assembly for sealing the second receptacle to impede the egress of filtered wastewater from the second receptacle. The seal assembly includes a receptacle seal for sealing the second receptacle and a seal seal for sealing the receptacle seal. Further, the valve includes a float assembly for unsealing the seal seal from the receptacle seal to, in turn, unseal the receptacle seal from the second receptacle when the wastewater in the second receptacle subsides.

### TECHNICAL FIELD

The present invention relates to a wastewater valve arrangement.

### BACKGROUND

The reference to any prior art in this specification is not, and should not be taken as an acknowledgement or any form of suggestion that the prior art forms part of the common general knowledge.

Wastewater systems, including sewage systems, are inherently affected by the presence of unwanted pressurized air in pipelines that can result in operational problems such as broken pumps, valves and pipes. In order to minimise these problems, air release valves (ARVs) are located at the highpoints of pressurised pipelines to de-aerate the pipelines and relieve any excess pressure.

An ARV typically includes a receptacle engaged with the pipeline to receive pressurized air and wastewater. A float valve is fitted to the receptacle and releases air in the receptacle as pipeline pressure increases. The float valve also permits the ingress of air into the receptacle as pipeline pressure decreases. The float valve further includes a float which rises with the wastewater level in the receptacle, to close the valve and thereby prevent wastewater from exiting the ARV.

In practice, wastewater flotsam builds up within the receptacle over time and can have a detrimental effect on the operation of the ARV. Accordingly, it is often necessary to periodically clean the interior of the receptacle from flotsam which can be an arduous task. Furthermore, wastewater flotsam can clog up the float valve and thereby render the ARV ineffectual.

Furthermore, the float is often in the form of a sealed ball which can implode or burst in the event of excess pressure in the receptacle, thereby also hindering the performance of the ARV.

PCT/AU2009/000707 discloses a wastewater valve arrangement for impeding clogging of the valve with flotsam and having an implosion resistant float.

However, in practice, ARVs on trunk sewer mains, in some cases where pumps from two or more trunk mains feed into a single trunk main, can occasionally be affected by water column separation. An example would be when pump #1 closes the ARV with water flow, and then pump #2 forces a column of air into the flow of pump #1. This can undesirably result in the ARV not opening because air pressure alone is holding it closed.

The preferred embodiment provides for improved opening of the ARV.

### SUMMARY

According to one aspect of the present invention, there is provided a wastewater valve arrangement including:
a first receptacle for receiving a filter to filter wastewater;
a second receptacle for receiving the filtered wastewater; and
valve means including:
   a seal assembly for sealing the second receptacle to impede the egress of filtered wastewater from the second receptacle, the seal assembly including a receptacle seal for sealing the second receptacle and a seal seal for sealing the receptacle seal; and
   a float assembly for unsealing the seal seal from the receptacle seal to, in turn, unseal the receptacle seal from the second receptacle when the wastewater in the second receptacle subsides.

Advantageously, air pressure holding the receptacle seal closed may be overcome as the float assembly unseals the seal seal from the receptacle seal to, in turn, unseal the receptacle seal from the second receptacle when the wastewater in the second receptacle subsides. The float assembly may weigh on the receptacle seal as wastewater in the second receptacle subsides.

The seal seal may be flexible and resilient. The seal seal may be cantilevered to peel away from the receptacle seal during unsealing. The seal seal may include a nitrile strip.

The float assembly may include a float. The float may be able to move relative to the receptacle seal. The float may include a sealed ball, and strengthening ribs protruding from the float to define gaps between the ball and the second receptacle to provide an implosion resistant float. The float assembly may include a shaft extending from the float. The float assembly may include a mount for mounting the seal seal.

The valve means may include a slider for sliding along the second receptacle, the slider including the receptacle seal. The slider may include ribs protruding from the receptacle seal to define gaps between the receptacle seal and the second receptacle to provide an implosion resistant slider. The receptacle seal may be tubular. The receptacle seal may define an air orifice which is sealed by the seal seal.

The slider may include a guide for guiding the slider along the float assembly. The guide may include an arm extending from the receptacle seal, and a tube for surrounding a shaft of the float assembly.

According to another aspect of the present invention, there is provided a valve means for a wastewater valve arrangement, the valve means including:
a seal assembly for sealing a receptacle to impede the egress of filtered wastewater from the receptacle, the seal assembly including:
   a receptacle seal for sealing the receptacle;
   and a seal seal for sealing the receptacle seal; and
a float assembly for unsealing the seal seal from the receptacle seal to, in turn, unseal the receptacle seal from the receptacle when the wastewater in the receptacle subsides.

According to another aspect of the present invention, there is provided a seal assembly of a valve means of a wastewater valve arrangement, the seal assembly including:
a receptacle seal for sealing a receptacle; and
a seal seal for sealing the receptacle seal.

According to another aspect of the present invention, there is provided method of unsealing a wastewater valve arrangement, the method including:
providing an receptacle seal for sealing a receptacle and a seal seal for sealing the receptacle seal; and
providing a float assembly for unsealing the seal seal from the receptacle seal to, in turn, unseal the receptacle seal from the receptacle when the wastewater subsides.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an exploded view of a wastewater air release valve (ARV) in accordance with an embodiment of the present invention;

FIG. 2 is a side perspective view of a float valve of the wastewater ARV of FIG. 1; and

FIG. 3A-3C shows the sequential steps of the float valve of FIG. 2 when unsealing the wastewater ARV of FIG. 1.

### DETAILED DESCRIPTION OF PREFERRED EMBODIMENTS

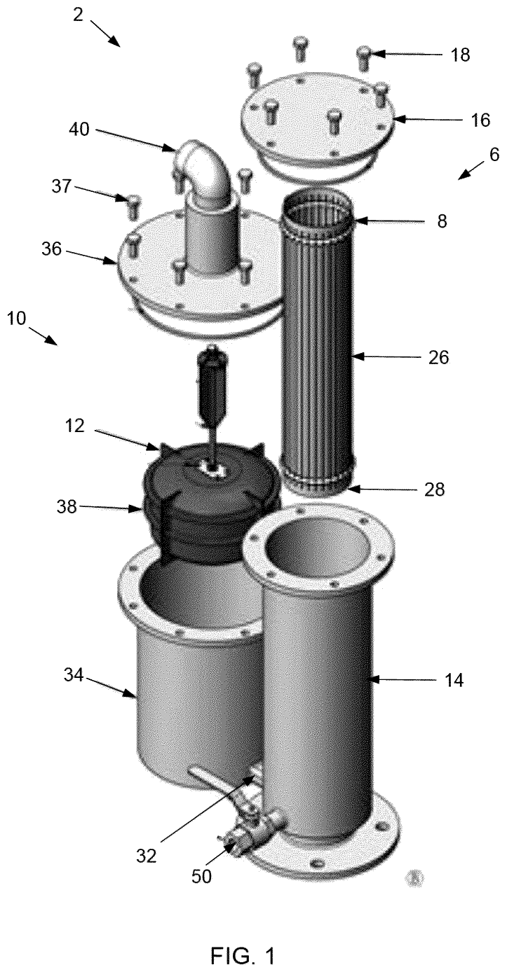

According to an embodiment of the present invention, there is provided a wastewater air release valve ARV 2 (i.e. arrangement) shown in FIG. 1. The ARV 2 is similar to PCT/AU2009/000707, which is incorporated herein by reference.

The ARV 2 is suitable for fitting to the pipeline of a sewage system. The ARV 2 includes a first filtration receptacle 6 for receiving a removable filter 8 to filter wastewater. A second valve receptacle 10 is provided for receiving the filtered wastewater from the filtration receptacle 6. The ARV 2 further includes a float valve 12 (i.e. valve means) in the valve receptacle 10. The float valve 12 permits the release (and ingress) of air relative to an outlet of the valve receptacle 10, and impedes the egress of filtered wastewater from the valve receptacle 10. A detailed description of the ARV 2 is provided in detail below.

The filtration receptacle 6 includes a container 14 to which a lid 16 can be fitted in air tight engagement using an O-ring (not shown). The lid 16 is releasably fastened to the container 14 using fasteners 18 that take the form of nut and bolt arrangements. A handle may be mounted to the lid 16 to facilitate hand separation of the lid 16 from the container 14. The base of the container 14 defines a throat from which a flange extends. The flange can be mounted to the pipeline using fasteners so that the throat of the container 14 is in register with an aperture defined in the pipeline.

The ARV 2 further includes the filter 8 which, in turn, includes an endless mesh wall 26. The filter 8 further includes a solid inlet tube 28 which extends from the base of the mesh wall 26. The base of the mesh wall 26 also defines a throat so that the inlet tube 28 has a lesser cross sectional area than the upper end of the mesh wall 26. The filter 8 can include a handle mounted to the top of the mesh wall 26 to facilitate hand removal of the filter 8 from the container 14.

A single connection tube 32 interconnects the receptacles 6,10 so that fluid can freely pass between them. A manual release valve 50 is provided to empty the filtration receptacle 6.

The valve receptacle 10 includes a container 34 and a lid 36 which can be fitted in air tight engagement using an O-ring (not shown). The lid 36 is releasably fastened to the container 34 using fasteners 37 that take the form of complementary nut and bolt arrangements. The lid 36 defines a central aperture through which the float valve 12 extends when fitted.

The float valve 12 includes a float 38 at its base. In use, wastewater filling the container 34 lifts the float 38. The float 36 is not prone to implosion.

The valve receptacle lid 36 includes a bent housing 40 in which an annular seat is fitted and defines an outlet of the valve receptacle 10. The float valve 12 engages with the seat to close the valve 12 and seal the valve receptacle 10. The float valve 12 is configured to be normally open and closes as the wastewater level rises in the valve receptacle 10.

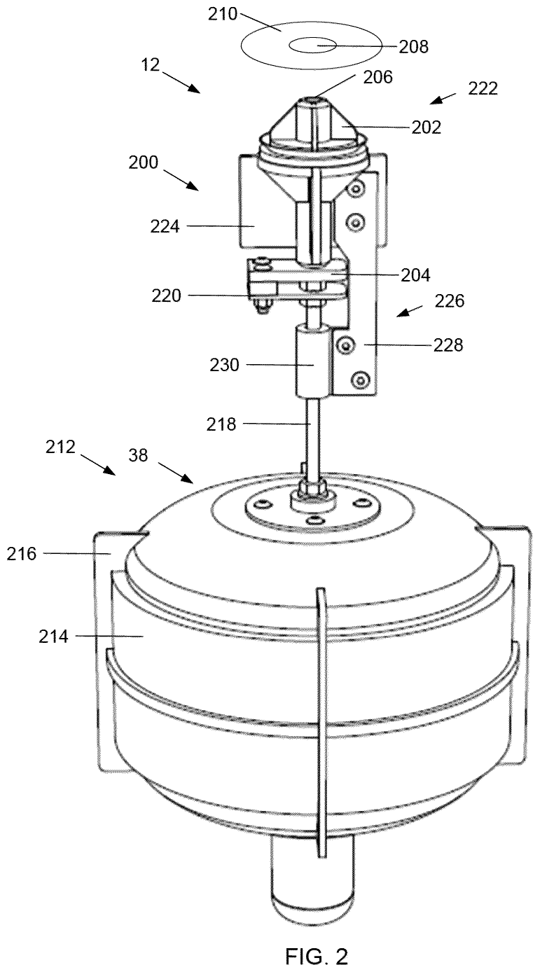

Turning to FIG. 2, the float valve 12 includes an upper seal assembly 200 for sealing the valve receptacle 10 to impede the egress of filtered wastewater from the valve receptacle 10. The seal assembly 200 includes a receptacle seal 202 for sealing against the valve receptacle 10 and a seal seal 204 for sealing against the receptacle seal 202. The receptacle seal 202 is tubular and defines an air orifice 206. The air orifice 206 is in register with the outlet 208 of the annular seat 210 in the valve receptacle lid 36. The air orifice 206 is also sealed at the bottom by the seal seal 204. The receptacle seal 202 seals against the annular seat 210.

The float valve 12 also includes a lower float assembly 212 for unsealing the seal seal 204 from the receptacle seal 202 to, in turn, unseal the receptacle seal 202 from the seat 210 of the valve receptacle 10 when the wastewater in the valve receptacle 10 subsides. Advantageously, air pressure holding the receptacle seal 202 closed is overcome as the float assembly 206 unseals the seal seal 204 from the receptacle seal 202. In turn, air pressure in the valve receptacle 10 equalises through the unsealed air orifice 206 to unseal the receptacle seal 202 from the valve receptacle 10 when the wastewater in the valve receptacle 10 subsides.

The seal seal 204 is flexible and resilient, and includes a nitrile strip. The seal seal 204 is cantilevered to peel away from the receptacle seal 202 during unsealing.

The float assembly 212 includes the float 38 which is able to axially move relative to the receptacle seal 202. The float 38 includes a sealed ball 214, and four vertical strengthening ribs 216 protruding from the float 38 to define gaps between the ball and the valve receptacle 10 to provide an implosion resistant float 38. The float 38 may also include a horizontal strengthening rib, and is integrally formed from plastics material by molding.

The float assembly 212 includes a central shaft 218 extending upwards from the float 38. Furthermore, the float assembly 212 includes a rigid strip mount 220 terminating the shaft 218 and for cantilever mounting the seal seal 204 at one end.

The top of the float valve 12 includes a slider 222 for sliding along the vertical portion of the bent housing 40 of the valve receptacle lid 36. The slider 222 includes the receptacle seal 202, and four vertical strengthening and centering ribs 224 protruding from the receptacle seal 202 to define gaps between the receptacle seal 202 and the valve receptacle lid 36 to provide an implosion resistant slider 222. The receptacle seal 202 and ribs 224 are integrally formed by molding.

The slider 222 also includes a rigid guide 226 for guiding the slider 222 along the shaft 218 of the float assembly 212. The guide 226 includes an arm 228 extending down from the receptacle seal 202 and ribs 224, and a tube 230 terminating the arm 228 and for surrounding the shaft 218. As wastewater in the valve receptacle 10 subsides, the float assembly 212 drops and the strip mount 220 moves toward the delimiter tube 230 causing the seal seal 204 to bend and peel away from the receptacle seal 202. The weight of the float assembly strip mount 220 on the slider tube 230 facilitates further unsealing of the receptacle seal 202, if it has not already occurred from the peeling away of the seal seal 204.

In use when the pipeline pressure increases, wastewater (i.e. sewage) including flotsam and other debris exits the pipeline and enters the filtration receptacle 6. In turn air in the filtration receptacle 6 passes through the connection tube 32, the valve receptacle 10 and out past the open float valve 12. As the wastewater level in the filtration receptacle 6 increases, wastewater passes into the valve receptacle 10 via the filter 8 and connection tube 32. Accordingly, flotsam is impeded from entering the valve receptacle 10 and remains within the filter 8.

Compressed air is trapped at the top the filtration receptacle 6 as the wastewater level rises therein above the connection tube 32. This compressed air cannot escape as the lid 16 is fitted in air tight engagement with the container 14, and facilitates flushing of flotsam back into the pipeline when the wastewater level (and pipeline pressure) drops. The wastewater fills the ARV 2 at a controlled rate and thereby prevents a shock or water hammer condition from occurring that might otherwise damage the ARV 2 or pipeline.

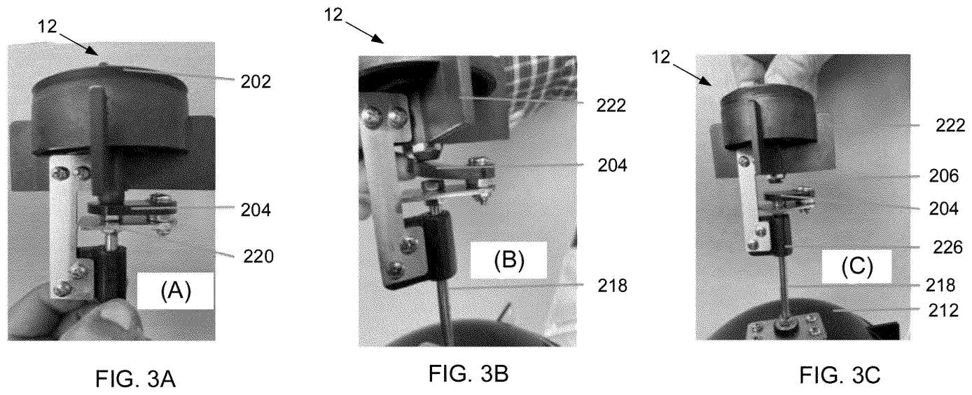

As the filtered wastewater level increases above a predetermined threshold within the valve receptacle 10, the valve 12 closes as previously described to thereby impede the egress of wastewater from the valve 12 as shown in FIG. 3A. The receptacle seal 202 seals against the seat 210 of the valve receptacle 10, and the seal seal 204 seals against the receptacle seal 202 blocking the air orifice 206. Air pressure in the valve receptacle 10 and the rising float assembly 212 hold the seals 202, 204 closed.

As the pipeline pressure drops with subsiding wastewater level in the valve receptacle 10, the float assembly 212 drops. As shown in FIG. 3B, the seal seal 204 peels away and is unsealed from the receptacle seal 202. The air orifice 206 is unsealed and the internal pressure of the valve receptacle 10 equalises with the outside atmospheric pressure so that, in turn, the receptacle seal 202 unseals from the valve receptacle 10.

As shown in FIG. 3C, the float assembly 212 now hanging on the guide 226 also weighs on the receptacle seal 202, should it stick, and the valve 12 fully opens once more to permit the ingress of fresh air into the ARV 2.

Periodically, the user can clean the ARV 2 of collected wastewater flotsam. The lid 16 is unfastened from the container 14 and removed. In turn, the user can readily remove the filter 8 from within the container 14. In practice, the filter 8 holds accumulated flotsam which is prevented from reaching and otherwise clogging the valve 12. Much of the heavier filtered flotsam rests in or upon the base tube 28 and can be extricated using a pipe cleaner. The mesh wall 26 of the filter 8 can be subsequently cleaned using a high pressure hose, and the filter 8 can then be returned to the cleaned container 14. The high pressure hose can also be used to clean the interior of the container 34 and float valve 12 upon removal of the lid 36.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

What is claimed is:

1. A wastewater valve arrangement, comprising:
a first receptacle for receiving a filter to filter wastewater;
a second receptacle for receiving the filtered wastewater; and
a valve including:
a seal assembly for sealing the second receptacle to impede the egress of filtered wastewater from the second receptacle, the seal assembly including a receptacle seal for sealing the second receptacle and a seal seal for sealing the receptacle seal; and
a float assembly for unsealing the seal seal from the receptacle seal to, in turn, unseal the receptacle seal from the second receptacle when the wastewater in the second receptacle subsides.

2. The wastewater valve arrangement as claimed in claim 1, wherein air pressure holding the receptacle seal closed can be overcome as the float assembly unseals the seal seal from the receptacle seal to, in turn, unseal the receptacle seal from the second receptacle when the wastewater in the second receptacle subsides.

3. The wastewater valve arrangement as claimed in claim 1, wherein the float assembly weighs on the receptacle seal as wastewater in the second receptacle subsides.

4. The wastewater valve arrangement as claimed in claim 1, wherein the seal seal is flexible and resilient.

5. The wastewater valve arrangement as claimed in claim 1, wherein the seal seal is cantilevered to peel away from the receptacle seal during unsealing.

6. The wastewater valve arrangement as claimed in claim 1, wherein the seal seal includes a nitrile strip.

7. The wastewater valve arrangement as claimed in claim 1, wherein the float assembly includes a float.

8. The wastewater valve arrangement as claimed in claim 7, wherein the float is able to move relative to the receptacle seal.

9. The wastewater valve arrangement as claimed in claim 7, wherein the float includes a sealed ball, and strengthening ribs protruding from the float to define gaps between the ball and the second receptacle to provide an implosion resistant float.

10. The wastewater valve arrangement as claimed in claim 7, wherein the float assembly includes a shaft extending from the float.

11. The wastewater valve arrangement as claimed in claim 1, wherein the float assembly include a mount for mounting the seal seal.

12. The wastewater valve arrangement as claimed in claim 1, wherein the valve includes a slider for sliding along the second receptacle, the slider including the receptacle seal.

13. The wastewater valve arrangement as claimed in claim 12, wherein the slider includes ribs protruding from the receptacle seal to define gaps between the receptacle seal and the second receptacle to provide an implosion resistant slider.

14. The wastewater valve arrangement as claimed in claim 12, wherein the slider includes a guide for guiding the slider along the float assembly.

15. The wastewater valve arrangement as claimed in claim 14, wherein the guide includes an arm extending from the receptacle seal, and a tube for surrounding a shaft of the float assembly.

16. The wastewater valve arrangement as claimed in claim 1, wherein the receptacle seal is tubular.

17. The wastewater valve arrangement as claimed in claim 1, wherein the receptacle seal define an air orifice which is sealed by the seal.

18. A valve for a wastewater valve arrangement, the valve comprising:
a seal assembly for sealing a receptacle to impede the egress of filtered wastewater from the receptacle, the seal assembly including:
a receptacle seal for sealing the receptacle;
and a seal seal for sealing the receptacle seal; and
a float assembly for unsealing the seal seal from the receptacle seal to, in turn, unseal the receptacle seal from the receptacle when the wastewater in the receptacle subsides.

19. A seal assembly of a valve of a wastewater valve arrangement, the seal assembly comprising:
a receptacle seal for sealing a receptacle; and
a seal seal for sealing the receptacle seal.
